(19) United States
(12) Patent Application Publication
(10) Pub. No.: US 2012/0021146 A1
(43) Pub. Date: Jan. 26, 2012

(54) Decorative Winged Insects and Methods of Making Decorative Winged Insects

(76) Inventor: Linda Leeming Schneider, Liberty Lake, WA (US)

(21) Appl. No.: 13/188,371

(22) Filed: Jul. 21, 2011

Related U.S. Application Data
(60) Provisional application No. 61/366,419, filed on Jul. 21, 2010.

(51) Int. Cl. B32B 9/00

(52) U.S. Cl. 428/16

(57) ABSTRACT

A decorative winged insect includes a single piece of translucent material in the shape of two or more insect wings; a crease in the single piece of translucent material between at least two of the two or more insect wings; and a body adhered to the piece of translucent material near the crease. Methods for making decorative winged insects, instruction documents for making decorative winged insects, and kits for facilitating the creation of decorative winged insects are also disclosed.

This application claims priority to U.S. Provisional Patent Application Ser. No. 61/366,419, which was filed on Jul. 21, 2010 and which is incorporated herein by reference.

### FIELD OF THE INVENTION

The present disclosure, in various embodiments, relates to crafts, specifically decorative winged insects and methods of making decorative winged insects.

### BACKGROUND

Decorative winged insects have been made from paper in the past, but tend not to be life-like in their appearance or movement.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 is a top view of a completed decorative winged insect, in this example a Monarch butterfly.

FIG. 2 is a bottom view of a completed decorative winged insect, including the double-sided adhesive used to attach the decorative winged insect to other objects.

FIG. 3 is a side view of a completed decorative winged insect, showing the lifelike expression of the decorative winged insect, including the double-sided adhesive used to attach the decorative winged insect to other objects.

FIG. 4: The first step in the process, creation of one half of the specimen. Create one wing and one-half of the specimen's body.

FIG. 5: Make an identical, reverse, mirror image of the original half resulting in two identical but reverse halves. Use a copy machine, scanner, computer, computer program, drawing utensil, laser print, digital, mechanical, electronic, or any other drawing device to create the reverse half.

FIG. 6: Move the two halves together to make a whole specimen with a full body and two wings.

FIG. 7, Step 1: Reproduce, transmit, copy, transfer the identical wings and body as a whole image to the desired end-product material using photocopy, silkscreen, dye, laser print, digital, mechanical, electronic or any other process. Step 2 is to apply color to the wings, as desired. Step 3 is to use any method to cut the image out.

FIG. 8: Fold the cut out image in half along the length of the body, matching the wings together exactly, and symmetrically.

FIG. 9: Open the specimen flat and apply black, glossy glue or paint to cover the body, not allowing the glue or paint to touch the wings.

FIG. 10: Before body material has congealed or dried, attach the two antennae to the head.

FIG. 11: After material has congealed or dried, refold wings together, letting wings relax naturally. Apply a double-sided adhesive to the underside of the specimen so it will attach to desired surfaces.

FIG. 12: A photograph of completed specimens, in this example, Monarch butterflies.

FIG. 13 illustrates example designs for moths and fantasy butterflies.

FIG. 14 is a photograph of decorative winged insects in accordance with an embodiment of the invention.

FIG. 15 is another photograph of decorative winged insects in accordance with an embodiment of the invention.

FIG. 16 is another photograph of decorative winged insects in accordance with an embodiment of the invention.

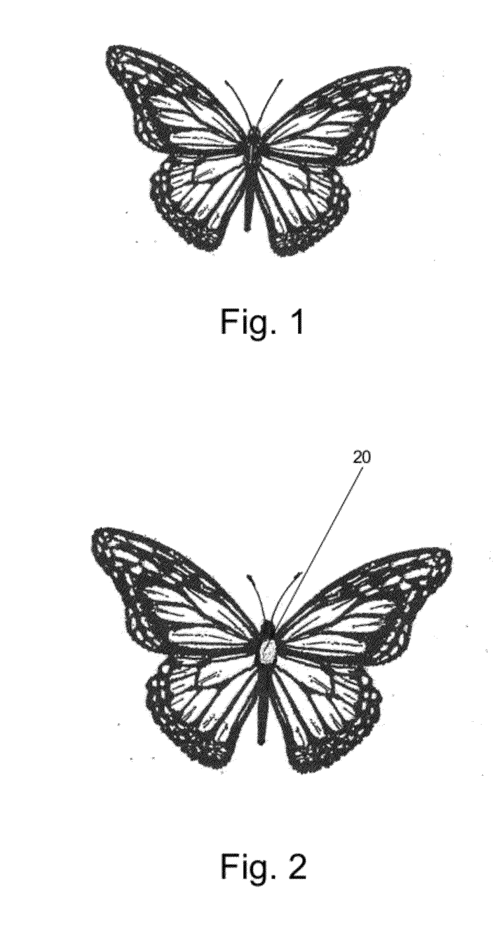

### DETAILED DESCRIPTION

Decorative winged insects (e.g., butterflies, moths, dragonflies, etc.) and methods for creating such are disclosed. The realistic, life-like butterflies and moths are almost indistinguishable from the live specimens, which they are designed to mimic. This invention includes a method of creating realistic, life-like butterflies and moths through a specific process. The decorative winged insects are extremely useful in artistic and creative areas such as florist shops, wedding and greeting card industries, scrap booking, innumerable do-it-yourself projects as well as for educational purposes. In addition to life-like winged insects, using the same materials and process, a fantasy (non-realistic, but attractive) butterfly, moth, or other winged insect may also be created by altering the wing pattern and design, rather than using realistic wing patterns and designs.

It is the combination of materials used that creates this unique decorative winged insect. Using one piece of semi-transparent, folded material rather than two separate pieces to form the decorative winged insect, causes the finished decorative winged insect to appear life-like with wing movement similar to actual winged insects, while remaining durable and flexible. A double-stick adhesive applied to the winged insect allows the winged insect to be unobtrusively attached to various surfaces without having to use conventional attachment devices such as wires, pins, clips, or suction-cups, thereby allowing the winged insect to appear more life-like.

### Operation

The decorative winged insect may be placed on a number of different surfaces as desired simply by lifting the decorative winged insect and pressing it onto the next location. If on an open surface, the wings may be left open and folded more vertically as a live butterfly or moth would rest its wings. For enclosed surfaces, e.g. cards, the wings may be pressed flat as the card is closed or slipped into an envelope

Known decorative butterflies use attachment devices such as wire, clips, suction cups, magnets and ‘feet’ or simply no attachment feature, simply allowing the decorative butterfly to lie freely. The attachment devices are far less flexible and more obtrusive than the realistic, life-like winged species in this invention. In this invention, the use of a double-sided adhesive that allows for placement of the decorative butterfly in a permanent or non-permanent manner is unique. Also, the technique of creating the specimen from one piece of material, applying a glossy, black, fabric paint or glue for the body, and then folding the wings upright to represent a three dimensional image while retaining the flexibility to become two dimensional or three dimensional, as needed, depending on the environment the species is placed in, is unique.

Known decorative butterflies have two distinct wings formed from two different pieces of material. The two distinct wings are attached to and separated by a body, most often a plastic body.

The decorative winged insects disclosed herein are almost undistinguishable from the live winged insects, which they are designed to mimic because the decorative winged insects have translucent wings capable of natural motion due to the materials used to form the decorative winged insects.

### Application

The decorative winged insects described herein are extremely useful in artistic and creative areas such as florist shops, wedding and greeting card industries, scrap booking, innumerable do-it-yourself projects as well as for educational purposes due to the attachment flexibility and the life-like presentation.

The ease of replication of this invention satisfies a consumer need for creativity and ownership, making the way for development of a kit for use in craft and educational purposes.

The realistic, life-likeness of this invention provides a way to enjoy the beauty of live winged insects without sacrificing a life. In one embodiment, the decorative winged insect may be associated with an original certificate of artistic authenticity stating the species scientific, Latin name of the species of winged insect that the decorative winged insect represents, signed by the artist, which could be of interest to collectors.

The invention is distinguishable over known decorative butterflies due to: the attachment device (double-sided adhesive) and; the technique of creating the decorative winged insect from one piece of material, applying a glossy, black, fabric paint or glue for the body, and then folding the wings upright to represent a three dimensional image while retaining the flexibility to become two dimensional or three dimensional, as needed, depending on the environment the decorative winged insect is placed in.

### Supplies

Designing utensils such as drawing materials, pencil, paper, pen, computer, drawing programs and stylus, scanner and printer, laser, die cuts.

Material for the wings and body of the species, for example any variety of papers, parchment, vellum, overlay heavy tracing paper, starched fabrics, other fabric, or plant material. Preferably, the wing material should be able to be creased, and once creased, should retain the crease substantially indefinitely or at least for several years. Various weights of wing material may be used including materials having a ream weight up to 90 lb. For wings that move in a life-like manner (e.g., flutter as a result of a breeze) the material should have a ream weight of 20 lb or less. The wing material may be translucent or opaque. However, for wings with a life-like appearance, the material should be translucent.

Paint (watercolor, latex acrylic, oil), colored pencils, pastels, dye, ink, or any other materials suitable for adding color to the wing material. The coloring added to the wing material may itself be either translucent or opaque.

Material for the body, any variety of fabric paint, acrylic/latex or polymer based compounds, chalking or oil based products. Gloss black is most often realistic. Material should hold its shape when applied, yet remain flexible in its final stage.

Antennae material for certain species, for example, a variety of fine wire, horsehair, human hair, sticks, plastic or plant material.

Adhesive such as double-sided adhesive dots or strips, sticky tape, foam double stick material, velcro and any other adhesive that will adhere to multiple surfaces such as glass, paper, plastic, metal, plant material, synthetic and natural fibers, wood, foam, textiles and more. By way of example, GLUE DOTS® brand adhesive products may be used.

### Method of Making

The following steps may be followed to make a decorative winged insect.

Create a drawing of the wings and all or a portion of the body of the decorative winged insect. This may be accomplished many different ways including the following.

In one embodiment, the drawing may be created on a computer using drawing or other graphic design software. The drawing may be printed to a piece of paper using a computer printer. In some cases, the drawing may be printed directly onto the wing material. Alternatively, the drawing may be printed to paper and then a copy machine may be used to copy the drawing from the paper to a piece of wing material.

In another embodiment, the drawing may be hand drawn directly onto the wing material using a marking device such as a pencil, pen, or paintbrush.

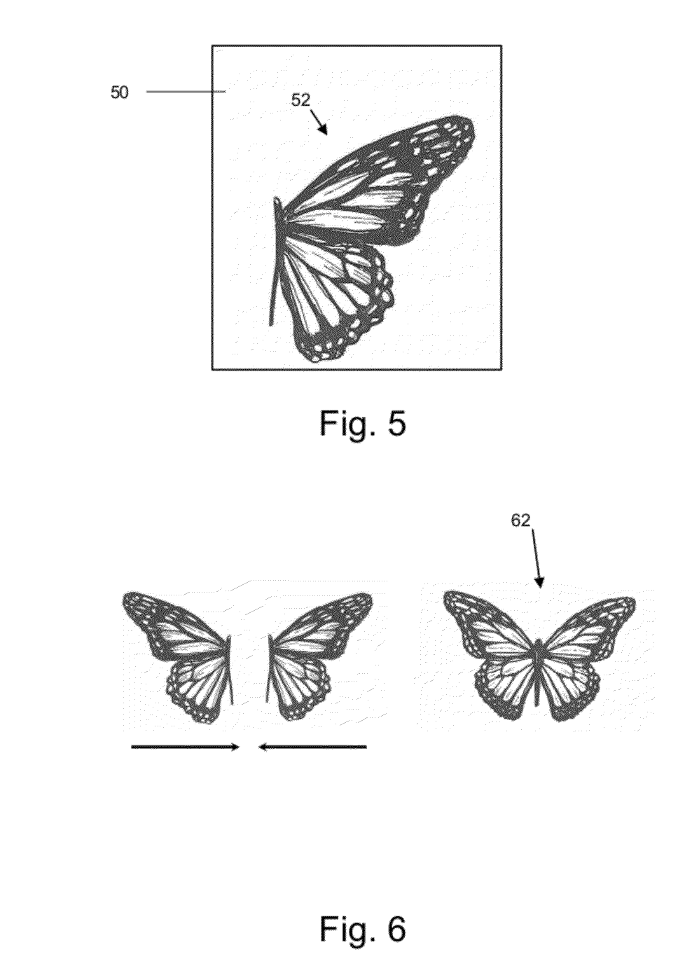

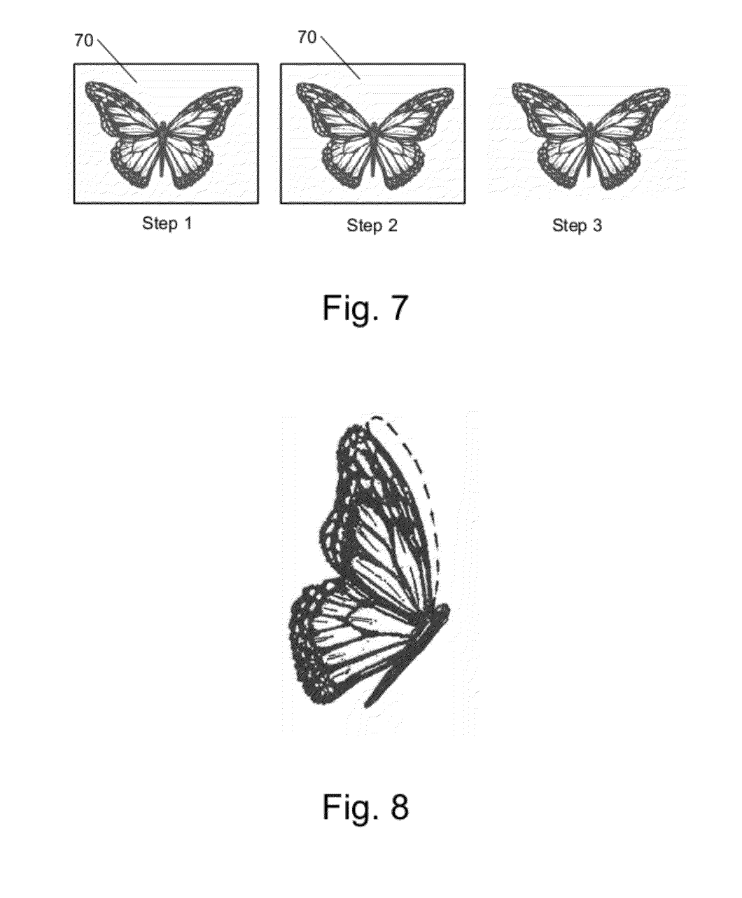

In some embodiments, the drawing may be symmetrical. In this case, the person creating the drawing need only create half the drawing 42 and then reflect and duplicate the half of the drawing and position the duplicated half 52 adjacent the original half (see FIG. 6), the result being a complete drawing 62 that is symmetrical. This method is discussed further below. First, as illustrated in FIG. 4, one wing and half of the body of the decorative winged insect is drawn either on material 40 (e.g., wing material, paper, etc.) or electronically via graphic design software. Next, as illustrated in FIG. 5, make an identical, reverse, mirror image 52 of the original half resulting in two identical but reversed halves. This may be done using a copy machine, scanner, computer, computer program, drawing utensil, laser print, digital, mechanical, electronic or any other drawing device to create the reverse half. The identical reverse mirror image of the original half may be created either on material 50 (e.g., wing material, paper) or electronically via graphic design software. Next, connect the two half bodies so that the wings are symmetrical and resulting in a complete drawing 62 as illustrated in FIG. 6, through the process of copying by hand, digital, electronic, photocopy, mechanical or by any other means. The connected halves may be created either on wing material, paper, or electronically via graphic design software. The connected halves of FIG. 6 represent the completed drawing. Next, reproduce the completed drawing onto the wing material 70 (see FIG. 7) by copying the completed drawing to wing material using a copy machine, printing the completed drawing onto the wing material using a computer printer, or by using silkscreen or any other suitable digital, mechanical, electrical, or other process.

Referring to FIG. 7, step 1 illustrated the completed drawing created (or reproduced) on a single piece 70 of wing material. This is referred to herein as the wing piece 70. Step 2 of FIG. 7 illustrates applying color to the wing piece 70 via paint, colored pencils, dye, ink or any other process to color the wings and body on the wing material. Step 3 of FIG. 7 illustrates cutting the wing piece 70 using a sharp implement such as scissors, cutting blade, laser, die cuts or any sharp implement, around the perimeter of the design.

FIG. 8 illustrates folding the cut wing piece in half along the length of the body and creasing the body in half while matching the wings together evenly and symmetrically. The folded cut wing piece may bring the wings to a three dimensional, almost vertical position.

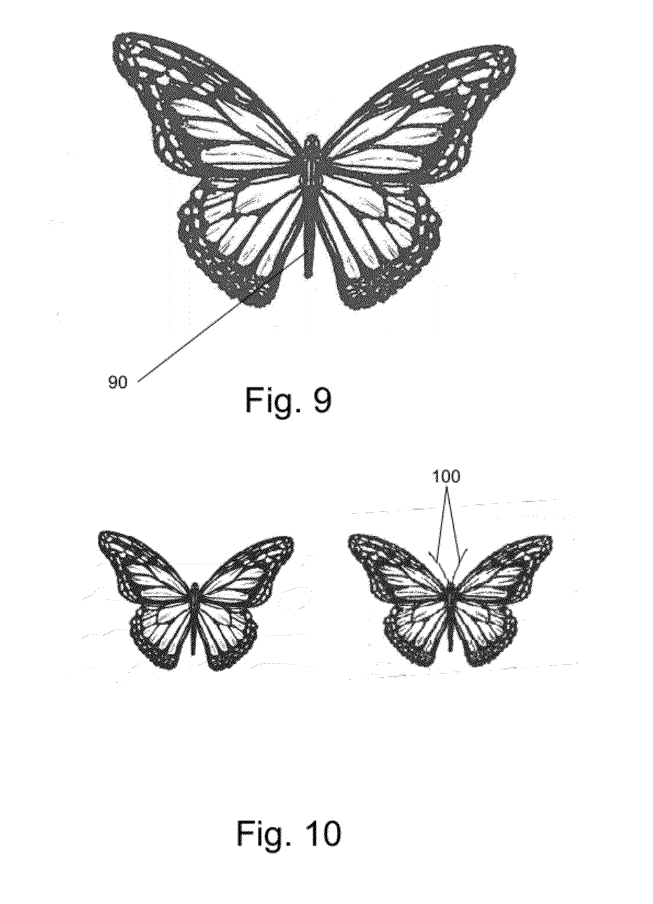

Next, as illustrated in FIG. 9, the folded cut wing piece is opened flat and body material is applied to the cut wing piece in the crease or valley where the body portion of the drawing is located between the paired wings using a thin strip, or line of fabric paint, acrylic/latex or polymer based compound, chalking or oil based products from head to tail on the long thin body. Alternatively, the body material could be applied to the folded cut wing piece along the apex of the crease on the side of the folded cut wing piece opposite the valley of the crease. The body material creates a three dimensional, flexible, elongated body 90 that may have dimensions proportional to a body of an actual winged insect portrayed by the decorative winged insect.

If creating a decorative winged insect with antennae, cut material such as fine wire, horsehair, human hair, miniature sticks, plastic or plant material to attach as the antennae (two pieces in length of appropriate proportion to specimen size, generally from ½ to 1 times the length of the body). Place the paired antennae 100 on the top where the head would be, while the body material is still pliable, or wet as illustrated in FIG. 10

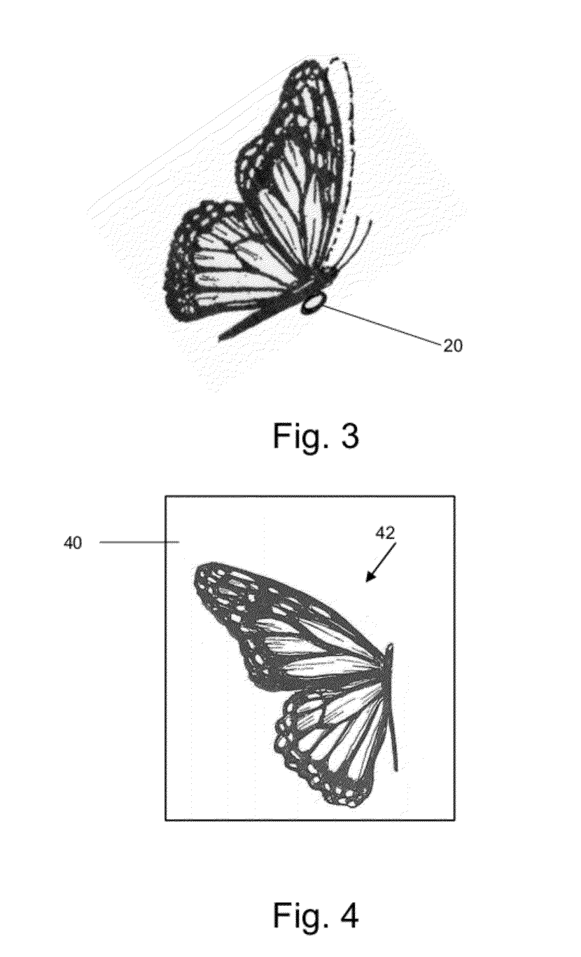

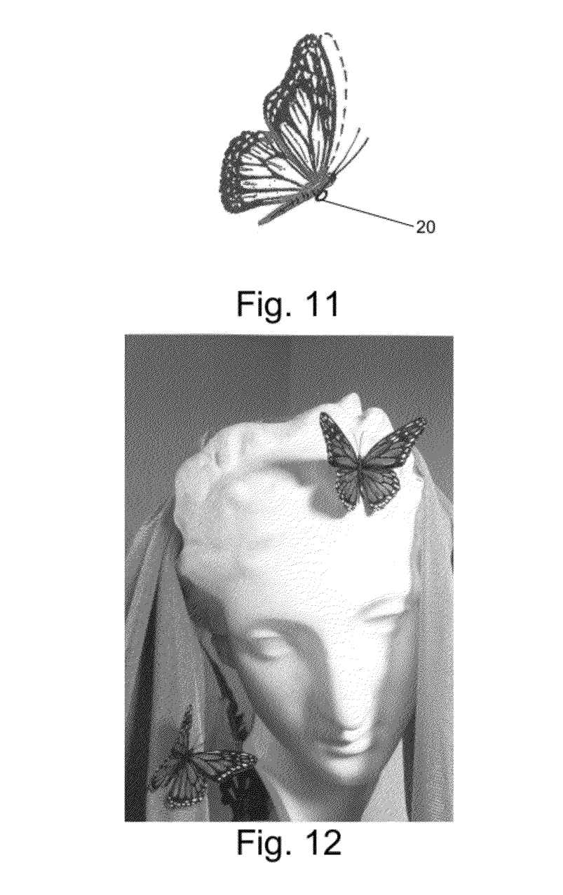

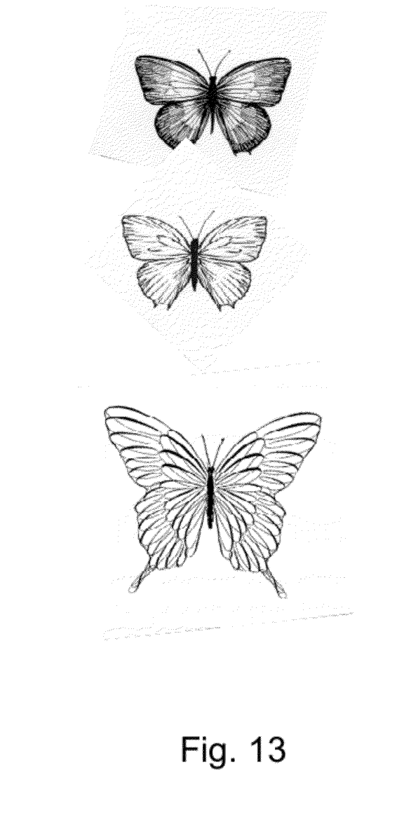

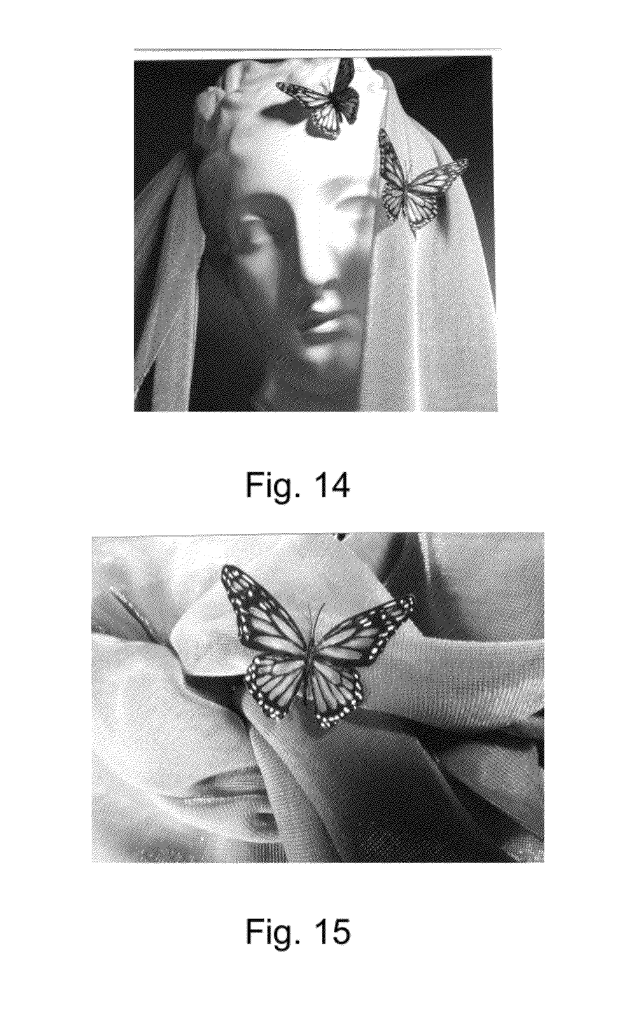

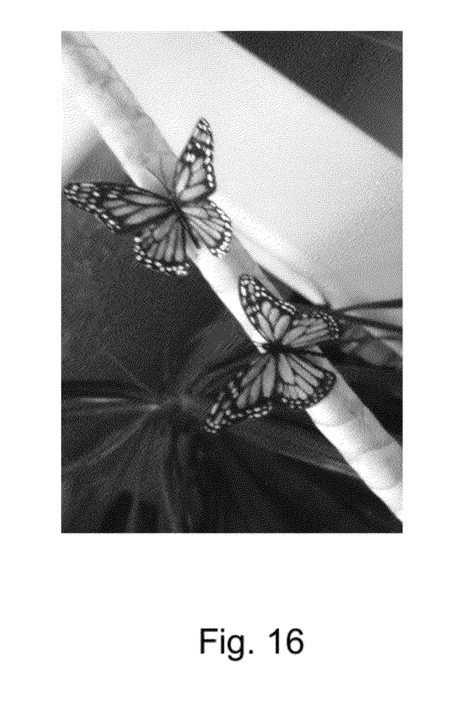

As illustrated in FIG. 11, refold the wings in a more vertical position. On side of the piece of wing material opposite the body material, place a small piece of double-sided adhesive 20 such as adhesive glue dots or strips (e.g., GLUE DOTS® brand adhesive products), sticky double-stick tape, VELCRO® brand fastener, or any other adhesive that will adhere to multiple surfaces such as glass, paper, plastic, metal, plant material, synthetic or natural fibers, wood, foam, or textiles. Preferably, the adhesive is placed on the vertex of the crease in the piece of wing material. Alternatively, if the body material is attached to the piece of wing material along the vertex of the crease as was described above, the adhesive may be attached to the body material. The adhesive allows the decorative winged insect to be semi-permanently attached to a desired surface, but also allows to decorative winged insect to be transferred to another surface. The adhesive is identified as 20 in FIGS. 2, 3, and 11.

### Book

In one embodiment, a book or other paper or electronic document may provide instructions for creating a decorative winged insect using the methods described herein. Furthermore, pre-painted wing material having a decorative wing design may be included in the book.

### Kit

According to one aspect of the invention, a kit for making a decorative winged insect may include: At least one wing design on either paper or wing material; Wing and body material; Insect body material; Antennae; Adhesive; paint; black marking pen; brush; Instructions describing a method of creating a decorative winged insect using the materials of the kit (and perhaps other materials not included in the kit such as colored pencils) and using one or more of the methods described herein. In one embodiment, the kit may also include a mold for creating a realistic insect body. The mold may be configured to accept fabric paint, glue, or other pliable material and may form the material into the shape of an insect body.

### CONCLUSION

It is the combination of materials used that creates this unique butterfly. Using one piece of semi-transparent, folded material rather than two separate pieces, causes the final butterfly to appear life-like, while remaining durable and flexible. The double-stick adhesive allows the butterfly to be unobtrusively attached to various surfaces, not limited to wires, pins, clips, or suction-cups, thereby allowing the butterfly to appear more life-like. The unique use of glossy, flexible black material for the body also contributes to the life-likeness of the specimens.

What is claimed is:

1. A decorative winged insect comprising:
a single piece of translucent material in the shape of two or more insect wings;
a crease in the single piece of translucent material between at least two of the two or more insect wings; and
a body adhered to the piece of translucent material near the crease.

2. The decorative winged insect of claim 1 wherein the body has dimensions proportional to an actual winged insect portrayed by the decorative winged insect.

3. The decorative winged insect of claim 1 wherein the piece of translucent material is flexible.

4. The decorative winged insect of claim 1 wherein the piece of translucent material comprises material having a ream weight of about 20 lb or less.

5. The decorative winged insect of claim 1 wherein the piece of translucent material flutters when in the presence of moving air.

6. The decorative winged insect of claim 1 further comprising translucent paint applied to the piece of translucent material.

7. The decorative winged insect of claim 1 further comprising an adhesive material attached to the body, the adhesive material having a sticky surface not in contact with the body, the sticky surface configured to adhere to an object and to support the weight of the decorative winged insect when adhered to the object.

8. The decorative winged insect of claim 4 wherein the adhesive material has a volume an order of magnitude smaller than the body.

9. The decorative winged insect of claim 4 wherein the sticky surface may be repeatedly adhered to a surface then removed from the surface without losing its stickiness.

10. The decorative winged insect of claim 1 wherein the body comprises glue.

11. The decorative winged insect of claim 1 wherein the body comprises fabric paint.

12. The decorative winged insect of claim 1 further comprising antennae attached to the body.
